(19) United States
(12) Patent Application Publication
(10) Pub. No.: US 2005/0264682 A1
(43) Pub. Date: Dec. 1, 2005

(54) Exposure control apparatus and exposure control method

(76) Inventor: Haruhisa Kurane, Suwa-shi (JP)

Correspondence Address: HARNESS, DICKEY & PIERCE, P.L.C., P.O. BOX 828, BLOOMFIELD HILLS, MI, 48303, US

(21) Appl. No.: 10/968,866

(22) Filed: Oct. 19, 2004

(30) Foreign Application Priority Data
Oct. 20, 2003 (JP) 2003-359087

(51) Int. Cl. H04N 5/235

(52) U.S. Cl. 348/362

(57) ABSTRACT

An exposure control apparatus is provided to perform an adjustment while changing the correction amount of a shutter speed of an image sensor and a gain of a PGA according to the magnitude of an exposure error so that the exposure error falls within an exposure allowable range. The exposure control apparatus changes the correction amount of the shutter speed and the gain at a specified different change rate according to control sensitivity inputted from a microcontroller. If a flicker phenomenon occurs after the exposure error is converged to within the exposure allowable range, the exposure control apparatus sets the control sensitivity to be low. Accordingly, it becomes possible to perform proper exposure control to detect objective information from the captured image.

### RELATED APPLICATIONS

This application claims priority to Japanese Patent Application No. filed 2003-359087 filed Oct. 20, 2003 which is hereby expressly incorporated by reference herein in its entirety.

### BACKGROUND

1. Technical Field

The present invention relates to an exposure control apparatus for controlling an image capture device which can detect objective information from a captured image and an exposure control method.

2. Related Art

Conventionally, in an image capture device used for measuring a specific object, such as a medical camera or a production line camera, objective information such as a tint or a luminance level (reflectivity) is detected from a captured image of the object (subject).

Specifically, the tint, the luminance or the like is converted into numbers and is acquired from the captured image, so that the state of the object is recognized.

In an image capture device, exposure control is generally performed in order to restrict the brightness of a captured image within a specified range.

In general, in the case where the exposure control is performed, the brightness of a captured image is measured and is converted into a number, and it is made an evaluated value of the brightness. The evaluated value is compared with a reference value (exposure objective value) of brightness set from the outside, and the electronic shutter speed of an image capture device and the gain of an amplifier are controlled so that they are almost coincident with each other. As a result, independently of variation of the brightness of a light source or the like, the brightness of the entire captured image becomes a value almost coincident with the exposure target value.

With respect to the exposure control as stated above, various techniques have been conventionally proposed.

For example, JP-A-6-141328 discloses a technique in which an electronic shutter speed, a gain and an iris are complexly controlled, so that the sensitivity of an image capture device is adjusted.

However, in the related art including the technique disclosed in the above publication, it is supposed that a person appreciates a captured image (a still image, moving image, etc.). Thus, in order to prevent a flicker phenomenon, the sensitivity in the exposure control is set to a low level.

That is, in the case where the sensitivity in the exposure control is set to a high level, there occurs a phenomenon (flicker phenomenon) in which the image capture device sensitively responses to a slight change of a light source or a subject to perform the exposure control, and the luminance level of the captured image is frequently changed. Accordingly, the response speed of the exposure control system is set to be slow (sensitivity of the exposure control is low). For example, the sensitivity of the exposure control is set to about ½ EV (Exposure Value) or ⅓ EV.

On the other hand, in the case of an image capture device used for measurement, since it is necessary to detect an accurate luminance level or tint of a subject, it is necessary to perform control so that a response is made at high speed and high accuracy to a luminance change of a light source, and a captured image is not influenced by the luminance change of the light source.

Accordingly, although it is necessary to perform the exposure control so that the luminance of the captured image is converged to an exposure target value at high speed and high accuracy, as described above, when the sensitivity of the exposure control system is made high, the flicker phenomenon occurs. Especially in the case where a correlation between frames is detected, it is not desirable that the shutter speed or the gain of the amplifier is frequently changed.

An object of the invention is to perform a proper exposure control in an image capture device for detecting objective information from a captured image.

### SUMMARY

In order to solve the above problem, according to the invention, an exposure control apparatus includes an image sensor (for example, an image sensor 11 of FIG. 1) provided with an electronic shutter, and an amplifier unit (for example, a PGA 12 of FIG. 1) for amplifying an output signal of the image sensor with a specified gain, performs an exposure control in which at least one of an electronic shutter speed of the image sensor and a gain of the amplifier unit is changed, so that brightness (for example, brightness expressed as a luminance evaluated value) of a captured image is adjusted to an exposure target value as a reference of brightness, and includes a sensitivity change unit (for example, an exposure control block 20 and a microcontroller 30 of FIG. 1) for changing, according to a control state of the exposure control (for example, “a state in which the brightness of the image is extensively separated from the exposure target value” or “a state in which although the brightness is close to the exposure target value, a flicker phenomenon occurs”, etc.), response sensitivity (for example, control sensitivity of FIG. 1) of the exposure control to changes in the brightness of the image.

By the structure stated above, since the response sensitivity corresponding to the exposure control state can be set, it becomes possible to make a flexible setting to the control sensitivity corresponding to the state. That is, it becomes possible to perform such a control that when the brightness of the image is made coincident with the exposure target value, the response sensitivity is made high and adjustment is performed to make the brightness coincident with the exposure target value at higher accuracy, or in the case where it is desired to prevent the flicker phenomenon from occurring, the response sensitivity is made low.

There is further included an adjustment unit for extensively changing, as a difference between the brightness of the image and the exposure target value becomes large when the brightness of the captured image is adjusted to the exposure target value as the reference of the brightness, at least one of the electronic shutter speed of the image sensor and the gain of the amplifier unit.

As a mode of changing at least one of the electronic shutter speed of the image sensor and the gain of the amplifier unit, it is possible to adopt both continuous changing and stepwise changing.

By the structure stated above, it becomes possible to quickly converge the brightness of the image to the exposure target value.

There is further included a flicker judgment unit (for example, a flicker detector 25 of FIG. 2) for judging whether the flicker phenomenon occurs, and in a case where the flicker judgment unit judges that the flicker phenomenon occurs, the sensitivity change unit sets the response sensitivity to be lower.

By the structure stated above, while the exposure control is performed at as high a sensitivity as possible, it becomes possible to take proper measures even in the case where the flicker phenomenon occurs.

When the brightness of the captured image is adjusted to the exposure target value as the reference of the brightness, the response sensitivity is set to a maximum value and adjustment is started, and in the case where the flicker judgment unit judges that the flicker phenomenon occurs after the brightness of the image is converged to the exposure target value, the sensitivity change unit sets the response sensitivity to be lower.

By the structure stated above, when the brightness of the image is converged to the exposure target value, priority is given to high accuracy, and after the convergence, priority is given to the prevention of the occurrence of the flicker phenomenon, and the exposure control can be performed.

According to the invention, an exposure control method is for an exposure control apparatus which includes an image sensor provided with an electronic shutter, and an amplifier unit for amplifying an output signal of the image sensor with a specified gain, and performs an exposure control in which at least one of an electronic shutter speed of the image sensor and a gain of the amplifier unit is changed, so that the brightness of a captured image is adjusted to an exposure target value as a reference of brightness, and includes a sensitivity change step of changing, according to a control state of the exposure control, the response sensitivity of the exposure control to changes in the brightness of the image.

As stated above, according to the invention, it becomes possible to perform proper exposure control in the image capture device for detecting objective information from the captured image.

### BRIEF DESCRIPTION OF THE DRAWINGS

FIG. 1 is a view showing a functional structure of an exposure control apparatus 1 according to an embodiment.

FIG. 2 is a view showing a functional structure of an exposure control block.

FIG. 3 is a view showing a functional structure of a correction amount calculation/gain setting part.

FIG. 4 is a view showing a relation between the magnitude of an exposure error and the correction amount of the correction amount calculation/gain setting part at maximum control sensitivity.

FIG. 5 is a view showing a relation between the magnitude of an exposure error and the correction amount of the correction amount calculation/gain setting part at medium control sensitivity.

FIG. 6 is a view showing a relation between the magnitude of an exposure error and the correction amount of the correction amount calculation/gain setting part at minimum control sensitivity.

FIG. 7 is a flowchart showing exposure control processing which a microcontroller of the exposure control apparatus carries out.

### DETAILED DESCRIPTION

Hereinafter, an embodiment of an exposure control apparatus of the invention will be described with reference to the drawings.

First, a structure will be described.

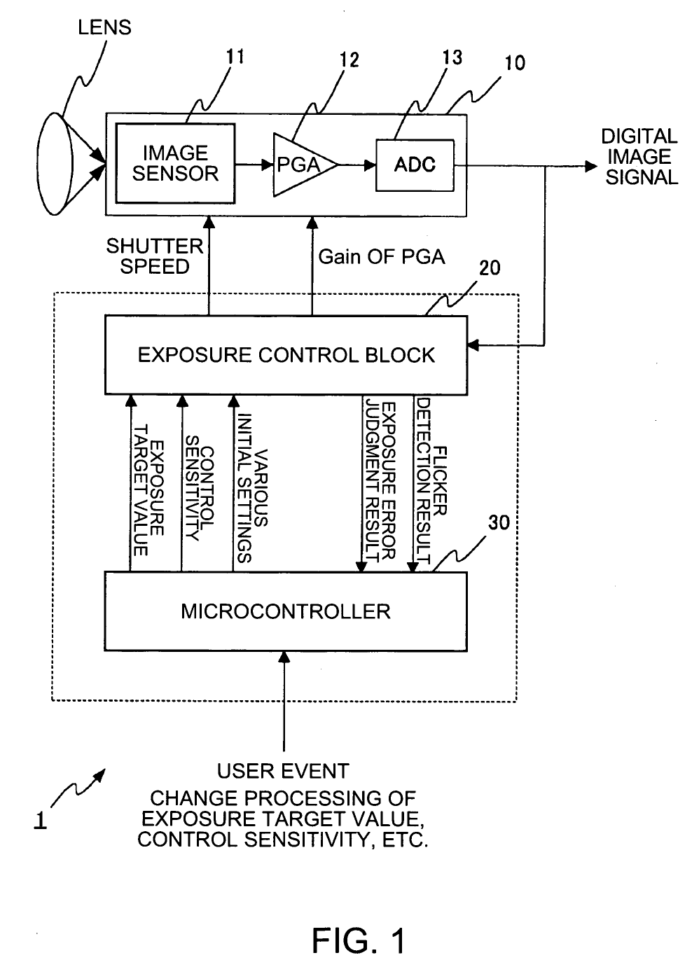

FIG. 1 shows a functional structure of an exposure control apparatus 1 according to an embodiment 1.

In FIG. 1, an exposure control apparatus 1 includes an analog/digital image capture part (hereinafter referred to as an “image capture part”) 10, an exposure control block 20 and a microcontroller 30.

The image capture part 10 includes an image sensor 11, a programmable gain amplifier (PGA: Programmable Gain Amp) 12, and an ADC (Analog to Digital Converter) 13.

The image sensor 11 is provided with an electronic shutter, and receives light inputted from a lens at a shutter speed set by the exposure control block 20. The image sensor 11 photoelectric-converts the received light (imaging of the lens) and outputs a signal expressing an image of a subject.

The PGA 12 amplifies the output signal of the image sensor with a gain set by the exposure control block 20.

The ADC 13 converts the output signal of the PGA 12 into a digital signal, and outputs it as a digital image signal.

Next, the exposure control block 20 will be described.

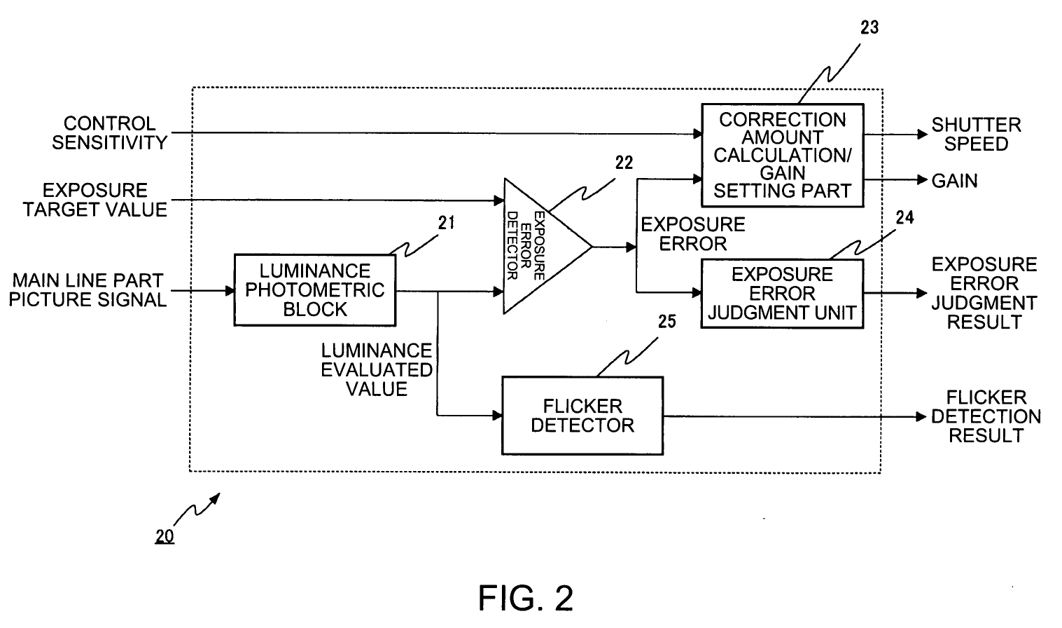

FIG. 2 is a view showing a functional structure of the exposure control block 20.

The exposure control block 20 includes a luminance photometric block 21, an exposure error detector 22, a correction amount calculation/gain setting part 23, an exposure error judgment unit 24, and a flicker detector 25.

When the digital image signal is inputted from the ADC 13, the luminance photometric block 21 integrates luminances of the respective pixels concerning an image of one frame, and makes an integration result a luminance evaluated value. The luminance photometric block 21 outputs the luminance evaluated value to the exposure error detector 22 and the flicker detector 25.

Incidentally, the logic to generate the luminance evaluated value in the luminance photometric block 21 is called luminance photometric logic. As the luminance photometric logic, in addition to a method of simply integrating the luminances of the pixels contained in one frame, it is possible to adopt a method in which on the assumption that the subject exists in the vicinity of the center of the frame, pixels in the vicinity of the center are weighted and are integrated, or a method in which a frame is divided by specified pattern to assign weights, and integration is performed.

The exposure error detector 22 calculates a difference between the luminance evaluated value inputted from the luminance photometric block 21 and an exposure target value inputted from the microcontroller 30, and outputs a difference value (hereinafter referred to as an “exposure error”) to the correction amount calculation/gain setting part 23 and the exposure error judgment unit 24.

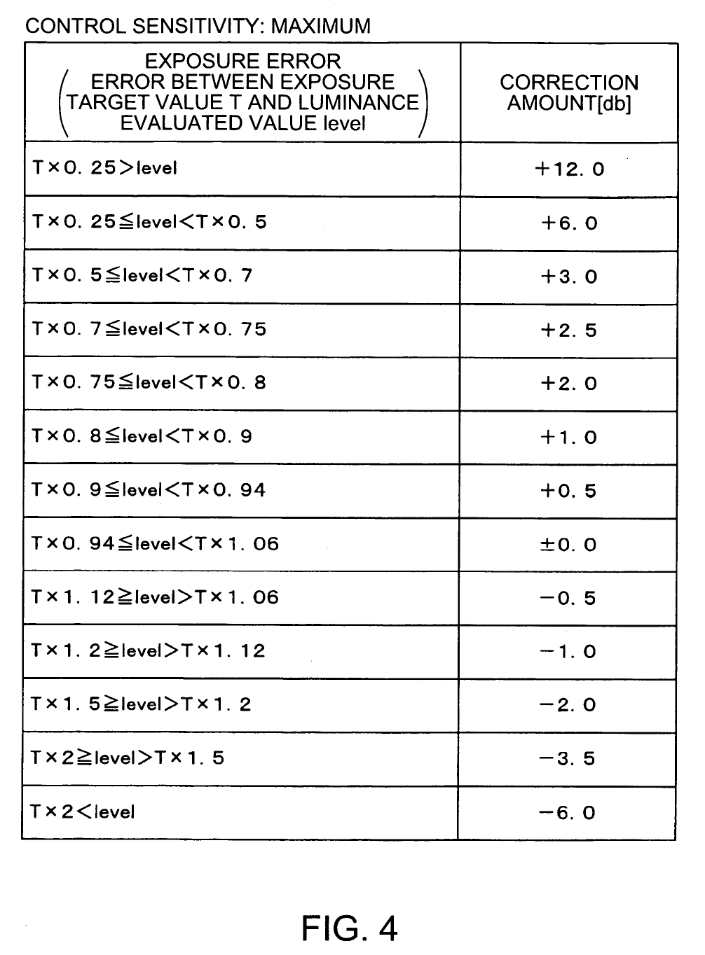

The correction amount calculation/gain setting part 23 adjusts the shutter speed of the image sensor 11 and the gain of the PGA 12 on the basis of the exposure error inputted from the exposure error detector 22 so that the exposure error falls within a specified range (hereinafter referred to as an “exposure allowable range”), and corrects the total gain of the image sensor 11 and the PGA 12. The exposure allowable range is set to be narrow when the control sensitivity is high and to be wide when the control sensitivity is low (see FIGS. 4 to 6).

The correction amount calculation/gain setting part 23 varies the change rate of a correction amount according to the control sensitivity inputted from the microcontroller 30 at the time when the shutter speed of the image sensor 11 and the gain of PGA 12 are corrected.

That is, the correction amount calculation/gain setting part 23 corrects the shutter speed of the image sensor 11 and the gain of the PGA 12 so that when the exposure error becomes large, the exposure error is changed at high speed and falls within the exposure allowable range, and corrects the shutter speed of the image sensor 11 and the gain of the PGA 12 in response to a small change of the exposure error when the control sensitivity becomes high.

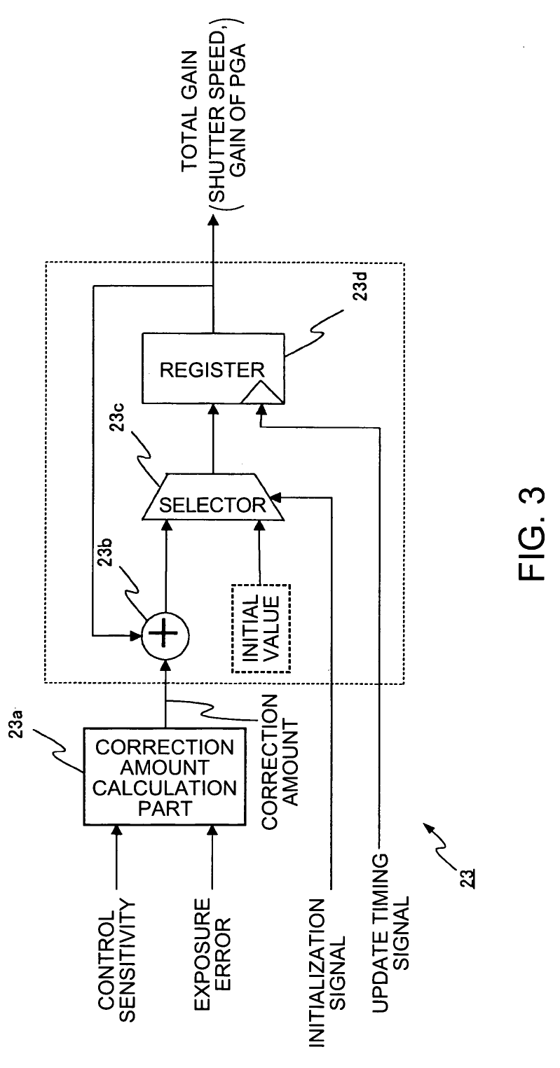

FIG. 3 is a view showing a functional structure of the correction amount calculation/gain setting part 23.

In FIG. 3, the correction amount calculation/gain setting part 23 includes a correction amount calculation part 23a, an adder 23b, a selector 23c and a register 23d.

As shown in FIGS. 4 to 6, the correction amount calculation part 23a stores data having a table format indicating the relation between the exposure error and the correction amount. When the exposure error inputted from the exposure error detector 22 and the control sensitivity set by the microcontroller 30 are inputted, the correction amount calculation part refers to the table, calculates the correction amount of the shutter speed of the image sensor 11 and the gain of the PGA 12, and outputs them to the adder 23b.

Incidentally, in order to correct the exposure error, it is possible to change one or both of the shutter speed of the image sensor 11 and the gain of the PGA 12, and the combination of the change amounts is arbitrary.

The adder 23b adds the correction amount inputted from the correction amount calculation part 23a to the present gain inputted from the register 23d, updates the total gain, and outputs it to the selector 23c. Incidentally, the total gain calculated here is two-dimensional data expressed by using the shutter speed of the image sensor 11 and the gain of the PGA 12 as parameters.

The selector 23c selects one of the gain inputted from the adder 23b after the update and the initial value of the gain according to the initialization signal generated in the microcontroller 30 or in the inside of the exposure control block 20, and outputs it to the register 23d.

The register 23d stores the gain inputted from the selector 23c after the update or the initial value of the gain in synchronization with an update timing signal. This update timing signal is generated at the time when the shutter speed of the image sensor 11 or the gain of the PGA 12 is changed, and is generally generated at a period equal to an integer times as large as the frame rate. The register 23d outputs the shutter speed of the image sensor 11 and the gain of the PGA 12 as parameters indicating the stored gains.

Here, the relation between the exposure error and its correction amount will be described.

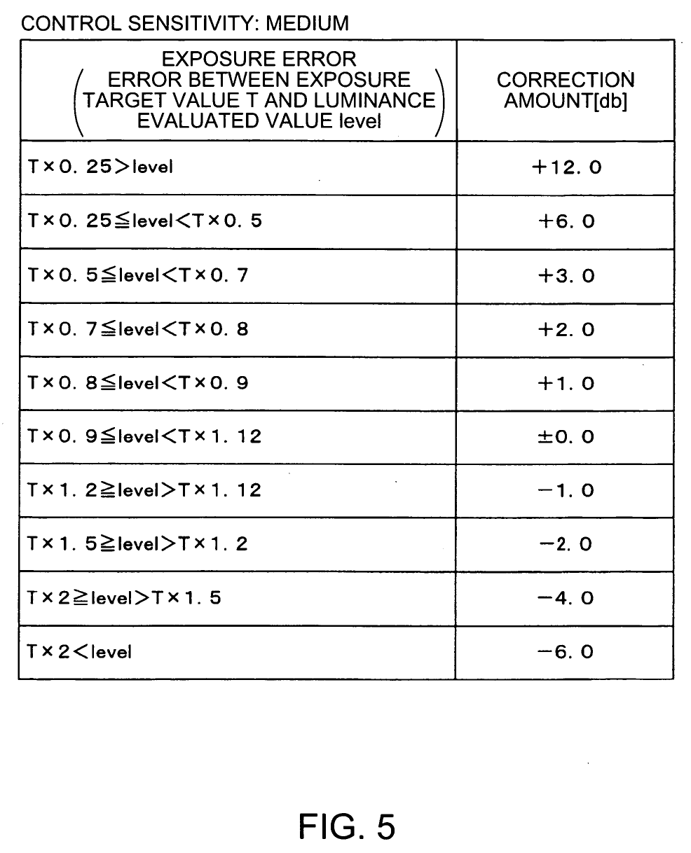

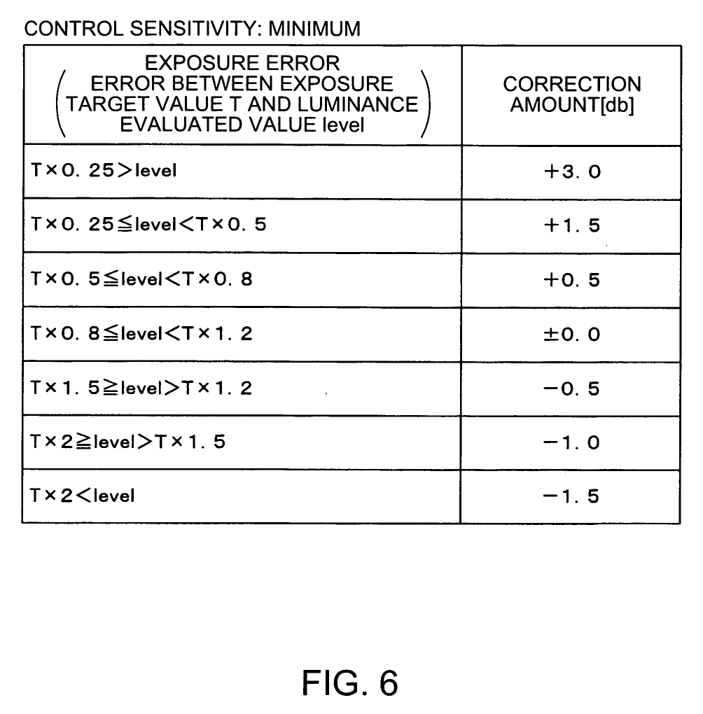

FIGS. 4 to 6 are views showing the relation between the magnitude of the exposure error and the correction amount of the correction amount calculation/gain setting part 23, FIG. 4 shows a case where the control sensitivity is set to a maximum, FIG. 5 shows a case where the control sensitivity is set to medium, and FIG. 6 shows a case where the control sensitivity is set to a minimum. In FIGS. 4 to 6, the exposure target value is denoted by “T”, the luminance evaluated value is denoted by “level”, and the correction amount corresponding to the error range of the luminance evaluated value “level” with respect to the exposure target value T is listed.

In FIG. 4, under the condition that the control sensitivity is maximum, in the case where the exposure error is ±6% (in the case where a ratio of the exposure target value to the luminance evaluated value is within ±6%), the correction is not performed, and each time the exposure error is magnified stepwise by a small level, the correction amount is extended by respective steps of 0.5, 1.0, 2.0, 2.5, 3.0, 6.0 and 12.0 db.

In FIG. 5, under the condition that the control sensitivity is medium, in the case where the exposure error is ±12% (in the case where a ratio of the exposure target value to the luminance evaluated value is within +12%), the correction is not performed, and each time the exposure error is magnified stepwise by a medium level, the correction amount is extended by respective steps of 1.0, 2.0, 3.0, 6.0, and 12.0 db.

Further, in FIG. 6, under the condition that the control sensitivity is minimum, in the case where the exposure error is ±20% (in the case where a ratio of the exposure target value to the luminance evaluated value is within ±20%), the correction is not performed, and each time the exposure error is magnified stepwise by a large level, the correction amount is extended by respective steps of 0.5, 1.5 and 3.0 db.

As stated above, since a setting is made such that the step of the correction becomes large as the exposure error is large, it becomes possible to converge the luminance evaluated value to the exposure target value at a high speed.

As the control sensitivity becomes high, the correction is performed for a small change of the exposure error, and therefore, when the control sensitivity is set to be high, it becomes possible to converge the luminance evaluated value to the exposure target value at a high speed and with high accuracy.

Further, as the control sensitivity becomes low, the exposure allowable range is set to be wide, and therefore, when the control sensitivity is set to be low in the case where the exposure error is within the exposure allowable range, it becomes possible to suppress the flicker phenomenon.

With reference to FIG. 2 again, the exposure error judgment unit 24 compares the exposure error inputted from the exposure error detector 22 with a specified threshold and outputs a signal (hereinafter referred to as an “exposure error judgment result”) indicating the comparison result. This threshold is a value for judgment of whether the exposure control by the correction amount calculation/gain setting part 23 has been converged, and specifically indicates, according to the control sensitivity, a boundary value of the exposure error at which the correction in FIGS. 4 to 6 is not performed (for example, in FIG. 4, a value corresponding to the exposure error of ±6%).

The flicker detector 25 judges, on the basis of the luminance evaluated value inputted from the luminance photometric block 21, whether or not the flicker phenomenon occurs, and outputs the judgment result (hereinafter referred to as “flicker detection result”).

That is, the flicker detector 25 compares the luminance evaluated values of several continuous frames with respect to adjacent frames, and judges, according to whether or not the difference value falls within a specified threshold, whether or not the flicker phenomenon occurs.

Since the threshold for judgment of whether or not the flicker phenomenon occurs depends on the environment where a camera (exposure control apparatus 1) is set up and the characteristics (S/N ratio etc.) of the camera, it is desirable to experimentally obtain the threshold in advance.

The microcontroller 30 carries out exposure control processing on the basis of the flicker detection result inputted from the exposure control block 20 and the exposure error judgment result. The microcontroller 30 sets the control sensitivity and the exposure target value of the exposure control block 20 and performs various initial settings by carrying out an input operation (user event) of a user or exposure control processing.

Next, an operation will be described.

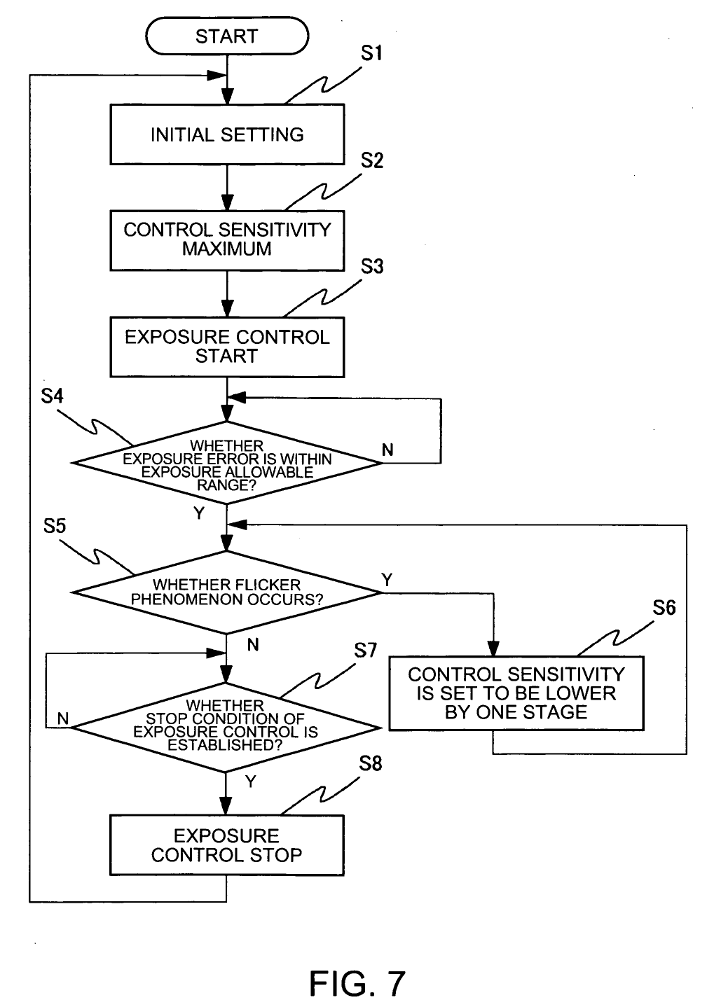

FIG. 7 is a flowchart showing exposure control processing which the microcontroller 30 of the exposure control apparatus 1 carries out. The exposure control processing is started at the same time as the turning-on of the power to the exposure control apparatus 1.

In FIG. 7, when the exposure control processing is started, the microcontroller 30 performs various initial settings for the exposure control block 20 (step S1), and sets the control sensitivity to be maximum (step S2). Here, the control sensitivity is set to a maximum in order to converge the exposure error to within the exposure allowable range at a high speed and to perform the exposure control with high accuracy.

The microcontroller 30 starts the exposure control by starting the exposure control block 20 (step S3), and performs a judgment as to whether or not the exposure error is within the exposure allowable range (step S4).

At step S4, in the case where it is judged that the exposure error is not within the exposure allowable range, the microcontroller 30 repeats the processing of step S4, and waits until the exposure error is corrected by the exposure control block 20. In the case where it is judged that the exposure error is within the exposure allowable range, the microcontroller performs a judgment as to whether or not the flicker phenomenon occurs (step S5).

At step S5, in the case where it is judged that the flicker phenomenon occurs, the microcontroller 30 sets the control sensitivity to a state lower by one stage in order to suppress the flicker phenomenon (step S6). In the case where it is judged that the flicker phenomenon does not occur, the microcontroller performs a judgment as to whether or not a stop condition of the exposure control is established (step S7).

Here, the stop condition of the exposure control corresponds to a case where a remarkable exposure error occurs, for example, a case where a scene change is performed or the luminance of a light source is extremely changed, or a case where a stop of the exposure control is instructed by a user or a host computer.

At step S7, in the case where it is judged that the stop condition of the exposure control is not established, the microcontroller 30 repeats the processing of step S7, and in the case where it is judged that the stop condition of the exposure control is established, the exposure control is stopped by stopping the operation of the exposure control block 20 (step S8).

After step S8, the microcontroller 30 proceeds to the processing of step S1.

As described above, while changing the correction amount of the shutter speed of the image sensor 11 and the gain of the PGA 12 according to the magnitude of the exposure error, the exposure control apparatus 1 of this embodiment performs the adjustment so that the exposure error falls within the exposure allowable range. Also, the exposure control apparatus 1 changes the correction amount of the shutter speed of the image sensor 11 and the gain of the PGA 12 at a specified different change rate according to the control sensitivity inputted from the microcontroller 30.

Accordingly, it becomes possible to converge the exposure error to within the exposure allowable range at a high speed and with high accuracy.

In the case where the flicker phenomenon occurs after the exposure error is converged to within the exposure allowable range, the exposure control apparatus 1 sets the control sensitivity to be low.

Accordingly, it becomes possible to suppress the occurrence of the flicker phenomenon while converging the exposure error to the exposure target value with high accuracy.

That is, according to the exposure control apparatus 1 of the invention, it becomes possible to perform the proper exposure control in order to detect the objective information from the captured image.

1. An exposure control apparatus comprising:
an image sensor including an electronic shutter; and
an amplifier unit amplifying an output signal of the image sensor with a specified gain;
wherein exposure control is performed in which at least one of an electronic shutter speed of the image sensor and a gain of the amplifier unit is changed so that brightness of a captured image is adjusted to an exposure target value as a reference of brightness;
the exposure control apparatus including a sensitivity change unit for changing, according to a control state of the exposure control, a response sensitivity of the exposure control to changes in the brightness of the image.

2. An exposure control apparatus according to claim 1, further comprising an adjustment unit for changing, as a difference between the brightness of the image and the exposure target value becomes large when the brightness of the captured image is adjusted to the exposure target value as the reference of brightness, at least one of the electronic shutter speed of the image sensor and the gain of the amplifier unit.

3. An exposure control apparatus according to claim 1, further comprising a flicker judgment unit for judging whether a flicker phenomenon occurs, wherein in a case where the flicker judgment unit judges that the flicker phenomenon occurs, the sensitivity change unit reduces the response sensitivity.

4. An exposure control apparatus according to claim 3, wherein, when the brightness of the captured image is adjusted to the exposure target value as the reference of brightness, the response sensitivity is set to a maximum value and adjustment is started, and in the case where the flicker judgment unit judges that the flicker phenomenon occurs after the brightness of the image is converged to the exposure target value, the sensitivity change unit reduces the response sensitivity.

5. An exposure control method for an exposure control apparatus which includes an image sensor with an electronic shutter, and an amplifier unit amplifying an output signal of the image sensor with a specified gain, and performs exposure control in which at least one of an electronic shutter speed of the image sensor and a gain of the amplifier unit is changed so that brightness of a captured image is adjusted to an exposure target value as a reference of brightness, the method comprising:
a sensitivity change step of changing, according to a control state of the exposure control, response sensitivity of the exposure control to changes in the brightness of the image.
